(19) United States
(12) Patent Application Publication
(10) Pub. No.: US 2003/0122314 A1
(43) Pub. Date: Jul. 3, 2003

(54) Biasing means of a face seal device

(75) Inventors: Peter Feigl, Hohenrain (DE); Clemens Simon, Starnberg (DE)

Correspondence Address: SUGHRUE MION, PLLC, Suite 800, 2100 Pennsylvania Avenue, N.W., Washington, DC, 20037-3213, US

(73) Assignee: BURGMANN DICHTUNGSWERKE GmbH & Co. KG

(21) Appl. No.: 10/329,468

(22) Filed: Dec. 27, 2002

(30) Foreign Application Priority Data
Dec. 27, 2001 (DE) 201 20 966.7
Aug. 14, 2002 (DE) 202 12 542.4

(51) Int. Cl. F16J 15/34

(52) U.S. Cl. 277/377

(57) ABSTRACT

A biasing means of a face seal device for applying a bias force between a pair of co-operating seal rings includes a pair of axially spaced support elements and a bias spring disposed between and supported by said support elements. The support elements are axially movable relatively to each other. Protruding means are provided on one of said support elements, with which the other support element can engage for limiting the axial movement of the support elements in a direction away from one another. The protruding means are spaced from the one support element by an axial distance larger than a predetermined maximum axial operational spacing the support elements can occupy after installation of the biasing means on the face seal device, and smaller than the axial length of the bias spring in a relaxed state.

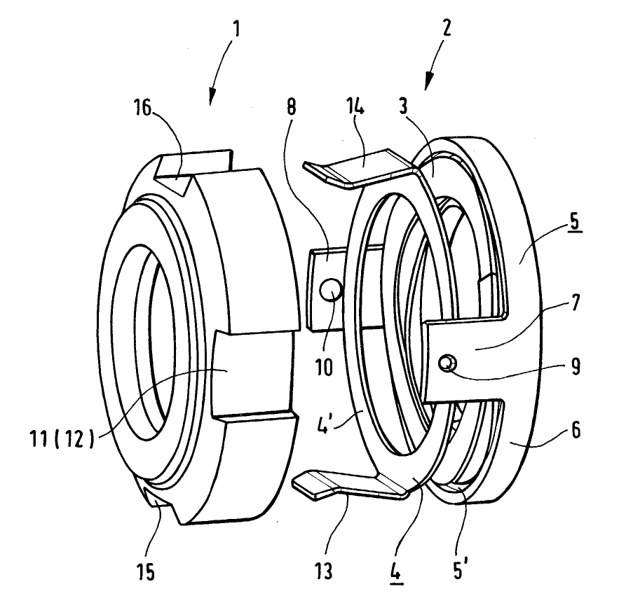

The following disclosure is based on German utility model application No. 20212542.4, filed on Aug. 14, 2002 with claim of priority of German utility model application No. 20120966.7, filed on Dec. 27, 2001, which both are incorporated into this application by reference.

### FIELD OF AND BACKGROUND OF THE INVENTION

The invention relates to a biasing means of a face seal device for applying a bias force between a pair of co-operating seal rings and more particularly to measures in face seal devices which can be assembled by means of robotic machines in automatic manufacturing plants and mounted on an equipment, e.g. a compressor casing. A starting point of the invention is a face seal device in which the mutually-aligned positional relationship between the seal rings of a face seal device is maintained both prior to and during assembly by means of an assembly device in the form of a mounting sleeve. The bias force required for urging the seal rings together in sealing engagement with each other during operation is applied by the biasing means which includes a support element and a drive element between which a bias spring is arranged.

### OBJECTS OF THE INVENTION

An object of the invention is to provide an improved biasing means of a face seal device. Another object of the invention is to provide a biasing means which permits assembly of a face seal device in fully automatic manner. Another object of the invention is to provide a biasing means of a face seal device suitable for automatic installation in apparatus like refrigerant compressors of air conditioning systems used e.g. in motor vehicles.

### SUMMARY OF THE INVENTION

These and other objects are solved in accordance with one aspect of the present invention by an improved biasing means of a face seal device for applying a bias force between a pair of co-operating seal rings is provided, which includes a pair of axially spaced support elements and a bias spring disposed between the support elements and supported thereby. The support elements are axially movable relatively to each other. Protruding means are provided on one of the support elements, with which the other support element can engage for limiting the axial relative movement of the support elements in a direction away from one another. The protruding means are spaced from the one support element by an axial distance larger than a predetermined maximum axial operational spacing the support elements can occupy after installation of the biasing means on the face seal device. The support element together with the bias spring can be clamped to a rotating seal ring of the face seal device by means of clamps. This is preferably effected after the co-operating seal rings have adopted their mutual positions on a mounting sleeve, or, after the seal rings have been placed on a shaft whilst in this positional relationship.

In the course of studies performed by the applicants of the present invention to further improve the handling of the individual components of the face seal device by means of robots in automatic assembly plants, it has been found, that in accordance with a preferred embodiment of the invention both the assembly of the biasing means itself and the assembly of the biasing means on a face seal device can be simplified significantly if the biasing means is formed as an independent mounting unit, in which the relative axial movement of the supporting elements, on which the bias spring is axially supported, is not only limited as above-mentioned but if this relative movement is limited to such an axial distance that the bias spring cannot enter a completely relaxed state. Thereby the bias spring is always held in a compressed state such that it exerts a certain, although reduced, spring force on the support elements urging one of them in engagement with the other thereby the support elements are held in a certain mutual position which creates a stable unit suitable for being grasped by handling machines and moved without a risk that the component parts of the biasing means will depart from their desirable mutual alignment before or during the assembly thereof on a face seal device, during transportation or when in storage. The bias spring enters its final operational state following mounting on the face seal device since the spring is then compressed to a further extent so that the bias spring can fulfil its function proper to urge one of the support elements towards the other during operation of the face seal device.

Thus in accordance with another aspect of the present invention a biasing means of a face seal device for applying a bias force between a pair of co-operating seal rings is provided, which includes a pair of axially spaced support elements and a bias spring disposed between and supported by said support elements, said support elements being axially movable relatively to each other, protruding means are provided on one of said support elements, with which said other support element can engage for limiting the axial movement of the support elements in a direction away from one another, said protruding means being spaced from said one support element by an axial distance larger than a predetermined maximum axial operational spacing the support elements can occupy after installation of the biasing means on the face seal device, and smaller than the axial length of the bias spring in a relaxed state.

Furthermore, the biasing means preferably simultaneously serves for conveying torque to the seal ring the biasing means is mounted to, in that the protruding means are provided on diametrically opposite mountings extending axially from one support element towards the other support element. These mountings are accommodated in axially movable manner in aligned recesses in the seal ring that is to be biased. This arrangement thus functions in a manner similar to a claw coupling. In accordance with another embodiment of the invention, the support elements may be parts of a metallic material made by a punching operation so that the support elements can be produced in a particularly economical manner.

### BRIEF DESCRIPTION OF THE DRAWING

The invention will be explained in more detail hereinafter with reference to the drawing showing an embodiment of the invention. The drawing shows in a partially schematic perspective view a biasing means in accordance with the present invention together with a seal ring of a face seal device to which a bias force is to be applied.

### DETAILED DESCRIPTION OF A PREFERRED EMBODIMENT

While a field of application of the invention is in face seal devices for sealing the drive shaft of a refrigerant compressor used for compressing a refrigerant such as CO₂, such refrigerants being employed e.g. in air conditioning systems of automobiles, it should be understood that the invention is not restricted to this field of application but will always offer advantages whenever the assembly of a face seal device should be effected automatically e.g. by means of so-called automatic robotic assembly plants.

The basic construction of a face seal device is known to a person skilled in the art and needs not be explained in detail at this point. Reference can be made to e.g. DE-U-20120966.7 which is thereby incorporated in the present disclosure of the invention. For the purposes of the present invention, it is sufficient to mention that a face seal device, with which the invention may be employed, comprises at least one pair of co-operating seal rings of which one is provided for mounting in non-rotational manner on a casing e.g. a compressor casing, and the other is provided for common rotation with a shaft. The seal rings have facing radial seal faces for sealing a portion peripherally outward of the seal faces relative to a portion peripherally inward thereof. In operation, a sealing gap can be formed between the seal faces which enables the face seal device to run in non-contact manner. Pumping grooves or recesses may be formed in the seal faces. As an alternative a sealing effect could be established by contacting-engagement of the seal faces.

The present invention relates to a biasing means for applying a suitable axial bias force to the rotary seal ring bearing the general reference number 1 in the drawing so as to urge the rotating seal ring against a stationary seal ring (not shown).

In the drawing, the biasing means is formed as a mounting unit which bears the general reference number 2 and comprises a bias spring 3 which is preferably in the form of a wave spring. The bias spring 3 is supported on a first support ring or support element 4 at one axial end thereof and on a second support ring or support element 5 at the other axial end thereof. The first support element 4 is designed such that the rotating seal ring 1 can be mounted thereon thereby torque will be transferred from the mounting unit 2 to the seal ring 1, as will subsequently be discussed in more detail.

Preferably, each support element 4, 5 is in the form of an annular washer or at least includes a radial base portion 4′, 5′ that is in the form of an annular washer (only that of the first support element 4 is shown). This not only ensures adequate axial support of the bias spring 3 on the mutually facing end faces of the support elements 4, 5, but it also enables an axial recess (not shown), which is formed in the seal ring 1 and opens onto the support element 4, in which a secondary sealing element (not shown) in the form e.g. of an O-ring can be arranged, to be axially covered when the first support element 4 rests on the facing end face of the seal ring 1, so that the secondary sealing element will be prevented from falling out of the recess.

As is shown, means are preferably provided on the mounting unit 2 for centering the bias spring 3 or holding it in an aligned relationship relative to the central longitudinal axis. For this, the second support element 5 remote from the seal ring 1 preferably comprises a peripheral flange 6 which projects axially therefrom and has a radial dimension which is such that it peripherally surrounds an adjacent portion of the bias spring 3 so as to center it without affecting the axial mobility of the spring. If desired, a similar centering arrangement can be provided on the first seal ring 4 in addition to or instead of the previously described arrangement. The peripheral flange 6 may be continuous or discontinuous.

A pair of axial arms or mountings 7, 8 axially project from diametrically opposite portions of the outer periphery of the second support element 5 towards the first support element 4. A protrusion 9, 10 radially inwardly projecting is provided near the outer axial end of each arm 7, 8. The diametrically opposite protrusions 9, 10 provide stops for the first support element 4 on which it can rest for limiting the axial movement of the support elements 4, 5 away from one another. The protrusions 9, 10 are preferably formed as beads or bosses stamped out from the material of the arms 7, 8, although other forms of protrusions could be provided including such ones not made in one-piece fashion with the arms.

For forming the biasing means as a mounting unit, the axial distance of the protrusions 9, 10 from the end face of the second support element 5 to which the arms 7, 8 are attached is, in accordance with the invention, dimensioned such that the bias spring 3 is still compressed axially by an appropriately small amount when the first support element 4 rests on the protrusions 9, 10. On the one hand the support elements 4, 5 and the bias spring 3 are held together thereby a mounting unit is created which can be handled in automatic production plants i.e. before the mounting unit is installed on a face seal device, whilst, on the other hand, the bias spring 3 can be further compressed to a certain extent when mounted on a face seal device so as to exert a desired operational bias force on the seal ring 1. Furthermore, this measure avoids a rigid connection between the bias spring 3 and one or both of the support elements 4, 5. The operational bias force is considerably larger than the axial force which the bias spring 3 exerts on the support elements 4, 5 prior to the installation of the mounting unit. The axial distance between the protrusions 9, 10 and the second support element 5 must be greater than the maximum operational spacing which the support elements 4, 5 adopt when the face seal device is in operation so that the first support element 4 will always disengage from the protrusions 9, 10 when the bias spring 3 is compressed such to provide the desired operational bias force in the course of the installation of the mounting unit. It is thereby ensured that the support elements 4, 5 can move axially relative to one another during operation. The maximum operational spacing is defined by the installation conditions of the particular face seal device.

It should be understood that the arms and the protrusions could also be provided on the first support element 4. Furthermore, if so desired, more than two arms and protrusions could be provided e.g. three or more arms equally peripherally spaced from each other.

In order to ensure free relative axial movement of the support elements 4, 5 when in operation, grooves or recesses 11, 12 (only one recess is shown in the drawing) are provided at diametrically opposite portions in the outer periphery of the seal ring 1, these grooves being aligned axially relative to the arms 7, 8. The arms 7, 8 are accommodated in the grooves or recesses 11, 12 such as to be axially movable therein when the bias spring 3 is compressed to an operational bias force and the seal ring 1 is in its operational position in which an adjacent end face thereof rests on the first support element 4. An interlocking coupling between the parts for conveying torque is obtained simultaneously.

For mounting the seal ring 1 on the mounting unit, a pair of clasps or clamps 13, 14 project from diametrically opposite portions of the outer periphery of the first support element 4 towards the seal ring 1. The clamps 13, 14 can engage in correspondingly aligned axial recesses 15, 16 in the outer periphery of the seal ring 1, this requiring a radial spreading of the clamps 13, 14. Consequently, the clamps 13, 14 exert a radial clamping and retaining force on the seal ring 1 and, furthermore, the clamps 13, 14 located in the recesses 15, 16 form another interlocking coupling between the parts for conveying torque.

Although this is not shown in the drawings, means are provided on the second support element 5 for connecting the support element 5 to a shaft for common rotation therewith. To this end, a through bore for the shaft in the second support element 5 may be provided with a so-called two-edge or multiple-edge arrangement which can engage in interlocking manner with a corresponding complementary edged portion of the shaft. Another form of coupling means serving for this purpose could likewise be provided.

The support elements 4, 5 and the arms 7, 8 or clamps 13, 14 are preferably formed by blanks of a metallic sheet material that are formed by punching and bending.

Prior to installation in a face seal device, the seal ring can be clamped to the biasing means formed as a mounting unit as previously mentioned, or the biasing means is applied subsequently to a pre-assembled seal ring.

The above description of a preferred embodiment has been given by way of example. From the disclosure given, those skilled in the art will not only understand the present invention and the attendant advantages, but will also find apparent various changes and modifications to the structures disclosed. It is sought, therefore, to cover all such changes and modifications as fall within the spirit and scope of the invention, as defined by the appended claims, and equivalents thereof.

What is claimed is:

1. A biasing means of a face seal device for applying a bias force between a pair of co-operating seal rings, including a pair of axially spaced support elements and a bias spring disposed between and supported by said support elements, said support elements being axially movable relatively to each other, protruding means are provided on one of said support elements, with which said other support element can engage for limiting the axial movement of the support elements in a direction away from one another, said protruding means being axially spaced from said one support element by a distance larger than a predetermined maximum axial operational spacing the support elements can occupy after installation of the biasing means on the face seal device.

2. The biasing means according to claim 1, wherein said protruding means are provided at an axial distance from said one support element smaller than the axial length of the bias spring in a relaxed state for forming the biasing means as a mounting unit.

3. The biasing means according to claim 1, wherein said protruding means comprise at least a pair of protrusions formed on diametrically opposite mountings extending axially from said one support element towards said other support element, said mountings are accommodated in axially movable manner in aligned recesses in the seal ring the biasing means is applied to.

4. The biasing means according to claim 1, wherein at least one of the support elements comprises means for centering the bias spring.

5. The biasing means according to claim 4, wherein said centering means includes a centering flange provided on said one support element, said flange peripherally surrounding an adjacent end portion of the bias spring.

6. The biasing means according to claim 1, wherein the bias spring comprises a wave spring.

7. The biasing means according to claim 1, wherein retaining clamps are provided on one of the support elements for peripheral frictional engagement with the seal ring the biasing means is applied to.

8. The biasing means according to claim 1, wherein at least a base portion of each support element is in the form of an annular washer.

9. The biasing means according to claim 1, wherein each support element is a part of metallic material made by punching.

10. A biasing means of a face seal device for applying a bias force between a pair of co-operating seal rings, including a pair of axially spaced support elements and a bias spring disposed between and supported by said support elements, said support elements being axially movable relatively to each other, protruding means are provided on one of said support elements, with which said other support element can engage for limiting the axial movement of the support elements in a direction away from one another, said protruding means being spaced from said one support element by an axial distance larger than a predetermined maximum axial operational spacing the support elements can occupy after installation of the biasing means on the face seal device, and smaller than the axial length of the bias spring in a relaxed state.
